(19) United States
(12) Patent Application Publication
(10) Pub. No.: US 2009/0003249 A1
(43) Pub. Date: Jan. 1, 2009

(54) Determination and Display of Endpoint Identities

(75) Inventor: Li Shen, Bellevue, WA (US)

Correspondence Address: LEE & HAYES PLLC, 601 W Riverside Avenue, Suite 1400, SPOKANE, WA, 99201, US

(73) Assignee: Microsoft Corporation, Redmond, WA (US)

(21) Appl. No.: 11/769,456

(22) Filed: Jun. 27, 2007

(51) Int. Cl. H04L 12/16

(52) U.S. Cl. 370/261

(57) ABSTRACT

Tools and techniques for determination and display of endpoint identities are described herein. The tools may provide machine-readable storage media containing machine-readable instructions for receiving responses to requests to open call sessions involving given endpoints, and for extracting human-understandable identification information from these responses. These instructions may also extract previously stored identification information associated with the endpoint, where the identification information was extracted from a previous response transmitted from the endpoint.

### BACKGROUND

Remote live conferencing technology continues to proliferate, becoming increasingly more accepted by organizations and individuals. Additionally, live conferencing solutions are offering more features and services.

Previous conferencing technologies typically allowed callers to dial into conferences using telephone numbers and infrastructure associated with public-switched telephone networks (PSTNs). However, with the advent of packet-switched communications technologies and protocols, these PSTN telephone numbers are sometimes replaced by computer-generated strings of alphanumeric characters that identify endpoints that are participating in a given event, or that are requesting particular services. Typically, these computer-generated strings are lengthy, and do not lend themselves readily to understanding and/or recognition by human readers. Thus, in these environments, a human user may receive a request that identifies its origin not with a name or phone number, but with a computer-generated string that may not be understandable and/or recognizable to the human user.

### SUMMARY

Tools and techniques for determination and display of endpoint identities are described herein. The tools may provide machine-readable storage media containing machine-readable instructions for receiving responses to requests to open call sessions involving given endpoints, and for extracting human-understandable identification information from these responses. These instructions may also extract previously stored identification information associated with the endpoint, where the identification information was extracted from a previous response transmitted from the endpoint.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “tools,” for instance, may refer to system(s), method(s), computer-readable instructions, and/or technique(s) as permitted by the context above and throughout the document.

### BRIEF DESCRIPTIONS OF THE DRAWINGS

Tools related to determination and display of endpoint identities are described in connection with the following drawing figures. The same numbers are used throughout the disclosure and figures to reference like components and features. The first digit in a reference number indicates the drawing figure in which that reference number is introduced.

FIG. 1 is a block diagram illustrating systems and/or operating environments in which tools and techniques for determination and display of endpoint identities may perform.

FIG. 2 is a combined block and flow diagram illustrating components and message flows related to an initial message exchange that results in associating a given endpoint with identity or identification information.

FIG. 3 is a combined block and flow diagram illustrating components and message flows for extracting previously-stored endpoint identification information, as at least part of identifying endpoints from which incoming requests originate.

FIG. 4 is a flow diagram illustrating processes for extracting the endpoint identification information from a response to a message.

FIG. 5 is a flow diagram illustrating processes for adding the previously-extracted endpoint identification information to a request.

### DETAILED DESCRIPTION

### Overview

The following document describes tools capable of performing and/or supporting many techniques and processes. The following discussion describes exemplary ways in which the tools provide for determination and display of endpoint identities. This discussion also describes other techniques and/or processes that the tools may perform.

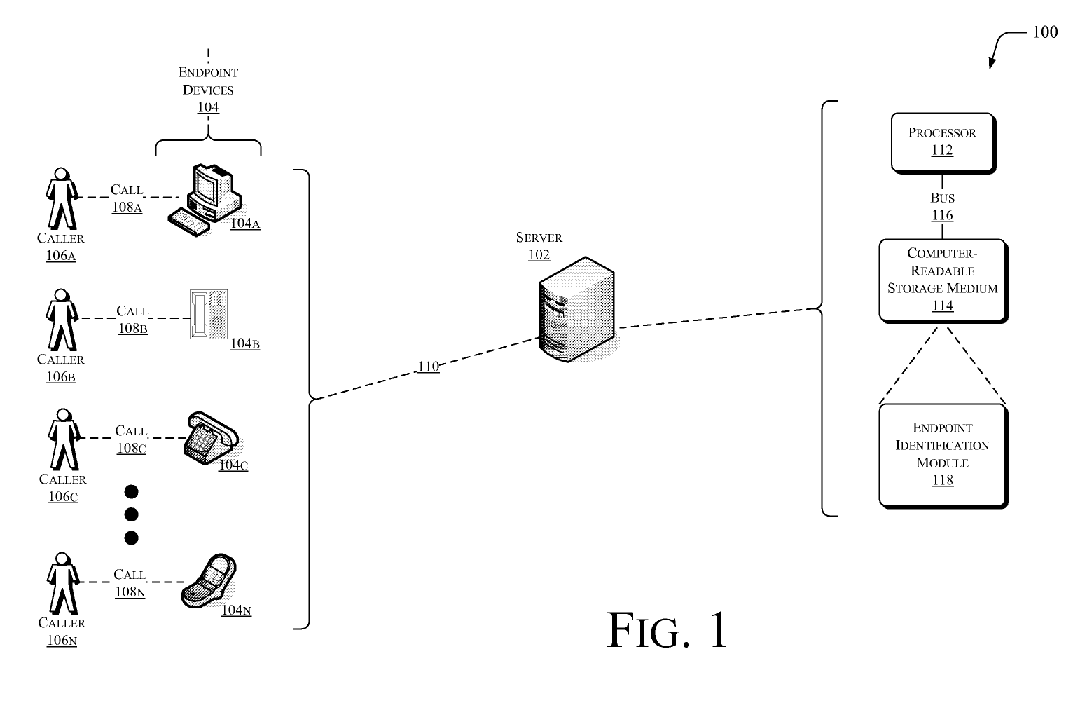

FIG. 1 illustrates systems and/or operating environments 100 in which tools and techniques for determination and display of endpoint identities may perform. The systems 100 may include one or more servers 102. In example implementations, these servers may represent any one of various types of servers for connecting a plurality of different endpoints to communicate via the Session Initiation Protocol (SIP). For example, the servers may include SIP proxy servers, media servers, gateway servers for interfacing a SIP environment to a public switched telephone network (PSTN), an audio-video multimedia control unit (AVMCU), or other suitable servers. However, it is noted that this description provides these example device only to facilitate discussion of the subject matter herein, but not to limit possible implementations of this subject matter.

FIG. 1 provides several non-limiting examples of endpoint devices 104 that may be coupled to communicate via the servers 102. Without limiting implementations, these endpoint devices 104 may include a desktop personal computer 104a, a desktop telephone 104b (which may be a SIP phone, a VoIP phone, or the like), a telephone 104c (which may be a phone connected to a PSTN), a mobile wireless device 104n (which may also represent smartphones or other wireless personal digital assistants (PDAs), or other suitable communication devices.

Respective callers 106a, 106b, 106c, and 106n (collectively, callers 106) may originate or receive calls 108a, 108b, 108c, and 108n (collectively, calls 108) involving one another, or involving other callers, via the server 102. FIG. 1 denotes the signaling, data, voice, and/or media transfers associated with these calls 108 generally at the dashed line 110.

Turning to the server 102 in more detail, the server may be a computer-based system that includes one or more processors, denoted at 112. These processors may also be categorized or characterized as having a given type or architecture, but in implementations that include more than one processor, these processors may or may not have the same type or architecture.

The device may also include one or more instances of machine-readable or computer-readable storage media, denoted generally at 114. The processor may communicate with the computer-readable media, and other components or sub-systems of the devices, via one or more busses 116. These busses 116 may be of any suitable width, and may comply with any convenient bus architecture.

The computer-readable media 114 may contain instructions that, when executed by the processor 112, perform any of the tools or related functions that are described herein as being performed by the server. The processor may access and/or execute the instructions embedded or encoded onto the computer-readable media, and/or may access data stored in the computer-readable media. Additionally, it is noted that the computer-readable storage media, and any software stored thereon, may reside on hardware other than that shown in FIG. 1 without departing from the scope and spirit of the description herein. The examples shown in FIG. 1 are provided only to facilitate discussion, but not to limit possible implementations.

Turning in more detail to the computer-readable media 114, it may include one or more modules of software instructions for determination and display of endpoint identities, denoted generally as an endpoint identity display module 118. For example, the module 118 may enable the identification of endpoints that originate requests that are incoming to the server 102. Additionally, the module 118 may enable displays of rosters of endpoints or callers that are currently participating in, for example, a multiparty event such as a conference call.

As a non-limiting example of displaying endpoint identities, assume that two or more of the callers 106 have formed an existing session between themselves, but later decide that they want to join an ongoing conference call. Assuming that the server 102 operates under SIP, the endpoint devices handling this existing session may issue a SIP Invite with Replace request to the server 102, requesting to replace the existing session with a session connected to the ongoing conference call. When the server receives the SIP Invite with Replace request, it may forward a call identifier (Call ID) associated with this request to one or more callers engaged in the conference call (e.g., any of the callers 106). Typically, this Call ID is a randomly-generated alphanumeric string that is not readily recognizable, readable, or understandable by humans. Without the benefits of the tools and techniques described herein, it may be difficult for a human caller to determine which endpoint has submitted the Invite with Replace request, and without this information, the caller may not readily act on the request, or may deny it without having any additional context. However, as described further below, the description herein provides techniques for enabling the human caller to visualize which endpoint has submitted the Invite with Replace request. By providing the caller with this information, the description herein may enable the caller to act on the request in a more informed manner.

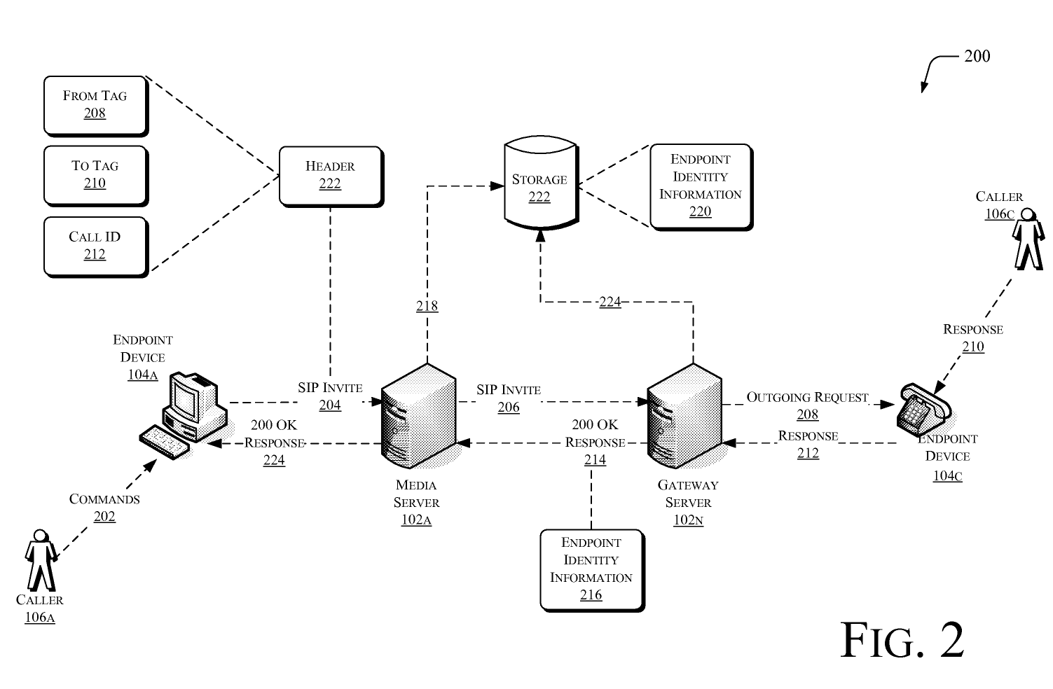

FIG. 2 illustrates components and message flows 200 related to an initial message exchange that results in associating a given endpoint with identity or identification information. For convenience of description, but not to limit possible implementations, FIG. 2 may carry forward some items described previously, and may denote them by similar reference signs.

The endpoint device 104a is carried forward from FIG. 1, and the caller 106a may initiate a session with, for example, the caller 106n. To request this session, the caller 106a may issue one or more commands 202 to the endpoint device 104a. In turn, the endpoint device 104a may formulate an appropriate request to open the session. FIG. 2 provides an example in which this request is a SIP Invite message 204, which in turn may include a header structure 206. Within the header structure, the SIP Invite message may include one or more of a From tag 208, a To tag 210, and a Call ID tag 212, in addition to other tags or fields not shown.

FIG. 2 provides an example of a media server, denoted at 102a to carry forward the previous description of the server 102 from FIG. 1. The media server 102a may receive the SIP Invite message 204, and forward it to be received eventually by the endpoint device 104c, which may be a PSTN device. The example shown in FIG. 2 provides a gateway server 102n between the server 102a and the endpoint device 104c. The gateway server may provide an interface between, for example, VoIP traffic between the servers 102 and PSTN traffic between the server 104n and the endpoint device 104c. FIG. 2 omits VoIP and PSTN networks in the interests of clarity.

The SIP Invite message as passed from the server 102a to the server 102n is denoted at 206. The gateway server 102n may output a call request 208 that corresponds to the SIP Invite message 206, with the endpoint device 104c notifying the caller 106c of the arrival of the call request in some appropriate manner. The endpoint device 104c may communicate any response 210 received from the caller 106c. FIG. 2 denotes at 212 this response as returned to the gateway server 102n.

Assuming the SIP implementation noted above, the gateway server 102n may convert the response 212 into a 200 OK response 214 (assuming for this example that conditions so warrant). The gateway server 102n, or another server performing similar functions, may add endpoint identification information 216 to the 200 OK response 214. For example, the server 102n may append a P-Asserted Identity header, as defined by SIP, to the 200 OK response 214. The endpoint identification information 216 may include a name of the caller 106c, a label, telephone number, or other human-readable, recognizable, and/or understandable identifier associated with the endpoint device 104c. On at least this basis, the endpoint identification information 216 is distinguished from the Call ID (e.g., 212).

In some implementations, the gateway server 102n may send the 200 OK response 214 and the added endpoint identification information 216 to the media server 102a. In turn, the media server 102a may store the endpoint identification information 216 for later reference, associated with the endpoint device 104c. FIG. 2 represents data flows associated with these implementations at the dashed line 218, which may represent the endpoint identification information 220 being loaded into storage 222.

In other implementations, the gateway server may load the endpoint identification information into the storage 222, as denoted at the arrow 224, and forward the 200 OK response 214 to the media server 102a.

In turn, the media server 102a may forward the 200 OK message to the endpoint device 104a, as denoted at 224. Afterwards, continuing a SIP example, the endpoint devices 104a and 104c may communicate further as defined under the SIP specification to complete the session and exchange media as part of the session.

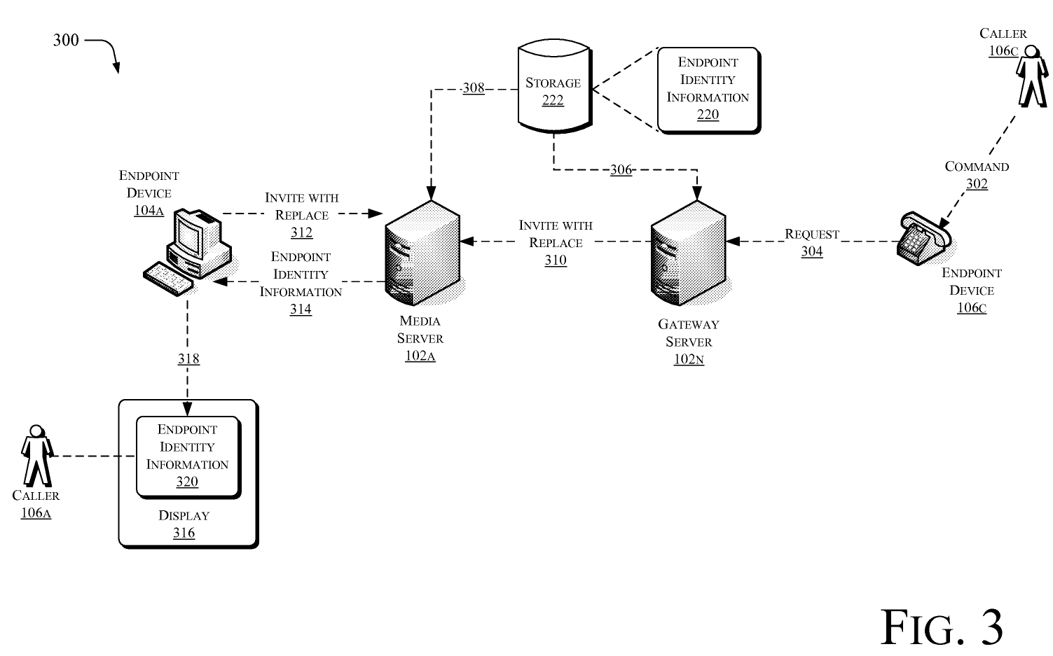

As appreciated from the foregoing description of FIG. 2, the tools and techniques described herein may store the endpoint identification information for retrieval and presentation during later message flows, as now described in FIG. 3.

FIG. 3 illustrates components and message flows 300 for extracting previously-stored endpoint identification information for presentation as at least part of a roster of incoming callers. For convenience of description, but not to limit possible implementations, FIG. 3 may carry forward some items described previously, and may denote them by similar reference signs.

FIG. 3 carries forward the caller 106c, who may submit a command 302 to the endpoint device 104c, with the command 302 relating to a session involving the endpoint device 104a, or possibly another endpoint device. For ease of description and reference, but not to limit possible implementations, FIG. 3 carries forward the endpoint 104a and the caller 106a. For example, the session referenced in FIG. 3 may be a separate session from that shown in FIG. 2, while involving the same callers, or perhaps different callers.

The endpoint device 104c forwards a call request 304 to the gateway server 102n, carried forward from FIG. 2. Having received the call request 304, the gateway server 102n may perform different functions in different implementations. For example, in some implementations, the gateway server may receive the request 304, determine which endpoint sent the request, and search the storage (e.g., 222) for any identification information (e.g., 220) associated with the sending endpoint. If the storage contains any identification information for the sending endpoint, then the gateway server may extract this identification information, as denoted by the dashed line 306. In other implementations, the gateway server may leave this function to the media server 102a, carried forward from FIG. 2. FIG. 3 denotes at 308 any data flows related to the media server extracting the endpoint identification information.

The gateway server may create an Invite with Replace request 310 based on the call request 304, and may forward this request 310 to the media server 102a. In implementations where the gateway server extracts the endpoint identification information (e.g., 306), the gateway server may include this endpoint identification information with the request 310. In implementations where the gateway server does not extract the endpoint identification information (e.g., 308), the gateway server may forward the request 310 only, leaving extraction of the endpoint identification information to the media server.

Turning to the media server 102a, it may receive the invite with replace request 310 from the gateway server. The media server 102a may also receive an invite with replace 312 from the endpoint device 104a. In turn, the media server may forward any identification information located for the endpoint 106c. FIG. 3 denotes at 314 any identification information for the endpoint device 106c as flowing from the server 102a to the endpoint device 104a.

In turn, the endpoint device 104a may receive the endpoint identification information 314, and may present it on a display 316 provided by the endpoint device 104a, along with any other suitable information relating to the Invite with Replace request 310. FIG. 3 denotes these data flows at the dashed line 318, and denotes the endpoint identification information 320. The display 316 enables the caller 106a to associate the incoming Invite with Replace request 310 with some information identifying the endpoint device 104c and/or the caller 106c. Based on the foregoing, the caller 106a may make a more informed decision in reacting to the Invite with Replace request 310.

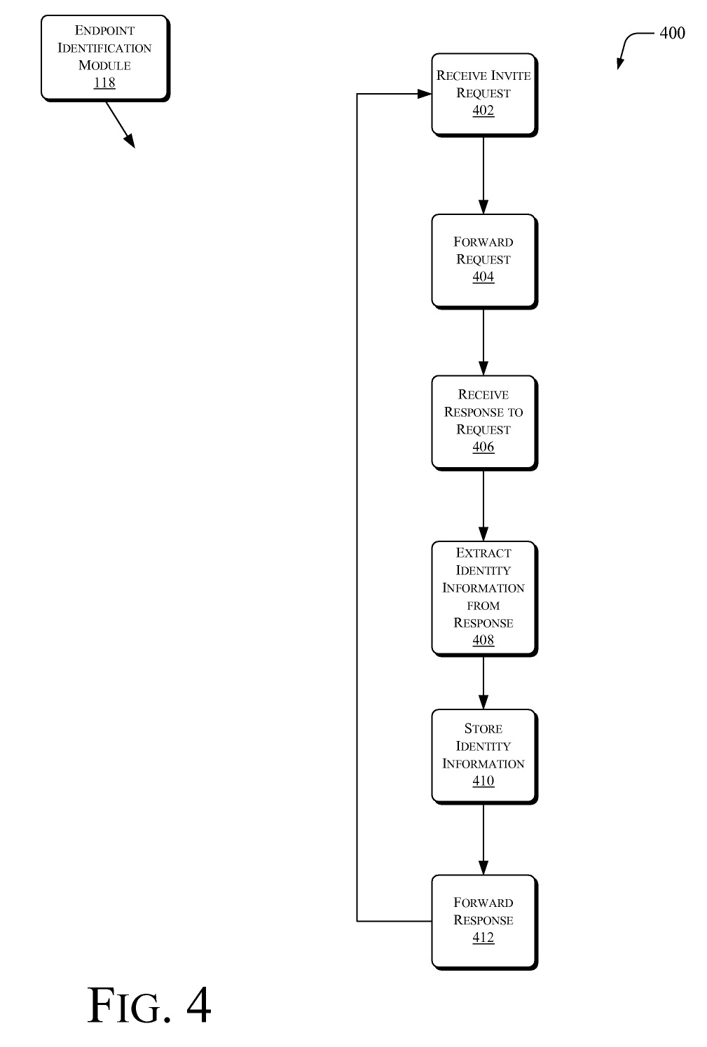

FIG. 4 illustrates process flows 400 for extracting the endpoint identification information from a response to a message. In the examples described herein, either of the servers as shown in FIG. 2 may perform the process flows 400. For convenience of description, but not to limit possible implementations, FIG. 4 may carry forward some items described previously, and may denote them by similar reference signs. Also, FIG. 4 illustrates scenarios in which the endpoint identity display module 118 performs the process flows 400, but it is noted that other systems or components may perform some or all of these process flows without departing from the scope and spirit of the description herein.

Block 402 represents receiving at least one request to open, join, or create a session between two or more callers. Assuming a SIP implementation, block 302 may include receiving a SIP Invite request. FIG. 2 shows examples of such a request at 204, as received by the media server 102a, and at 206, as received by the gateway server 102n.

Block 404 represents forwarding the request received in block 402. FIG. 2 provides examples of forwarded requests (e.g., SIP Invite requests) at 206, and at 208.

Block 406 represents receiving at least one response to the request. FIG. 2 provides an example of such a response at 210. In at least some cases, this response may include an SIP “200 OK” response, as denoted at 214 and 224. This response may include endpoint identification information inserted to identify an endpoint using some human-readable, recognizable, and/or understandable label or tag. For example, this response may have appended a P-Asserted identity header, with the header including the value: phone_number@domain.

Block 408 represents extracting endpoint identification information from the response received in block 406. FIG. 2 shows an example of the extracted endpoint identification information at 216.

Block 410 represents storing the extracted endpoint identification information for later reference. FIG. 2 shows an example of storage at 222, and the endpoint identification information as stored at 220.

Block 412 represents forwarding the response received in block 406. FIG. 2 provides examples of forwarded responses at 214 and 224.

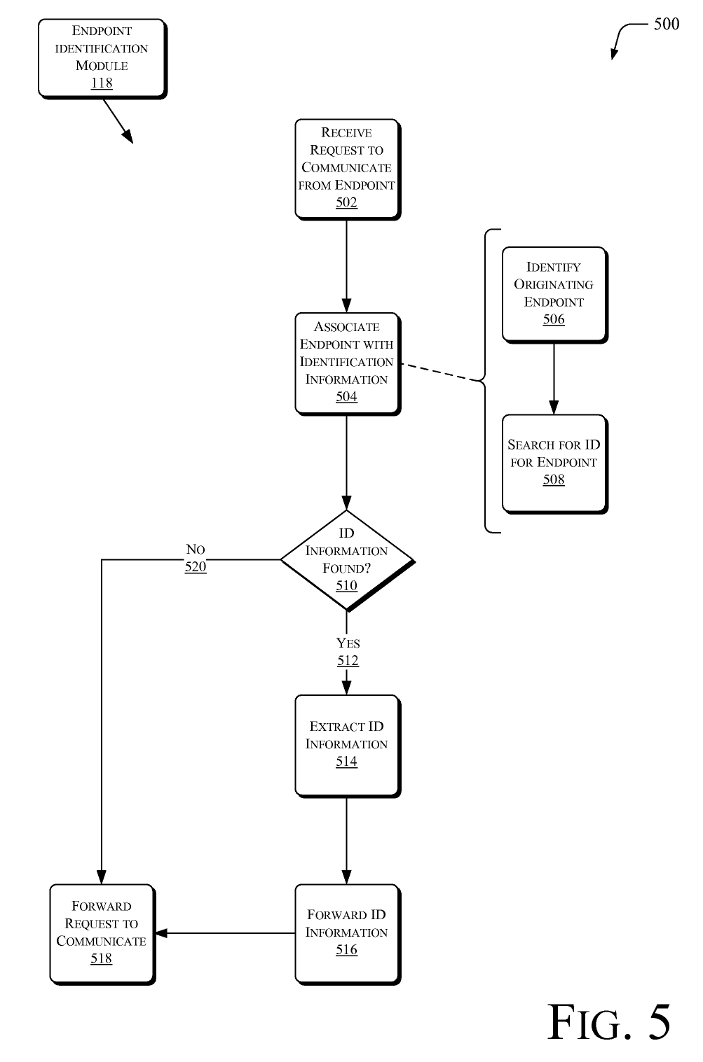

FIG. 5 illustrates process flows 500 for adding the previously-extracted endpoint identification information to a request. In the examples described herein, either of the servers as shown in FIG. 3 may perform the process flows 500. For convenience of description, but not to limit possible implementations, FIG. 5 may carry forward some items described previously, and may denote them by similar reference signs. Also, FIG. 5 illustrates scenarios in which the endpoint identity display module 118 performs the process flows 500, but it is noted that other systems or components may perform some or all of these process flows without departing from the scope and spirit of the description herein.

Block 502 represents receiving at least one command or request to join or create a session, as received from an endpoint. FIG. 3 provides an example of such commands or requests at 302 and 304.

Block 504 represents associating the requesting endpoint with any identification information available for the endpoint. For example, block 504 may include identifying the endpoint that originated the command or request received in block 502, as denoted at block 506. Block 504 may also include searching for any identification information stored for that endpoint, as denoted at 508. FIG. 3 provides examples of searching storage 222 for the endpoint identification information 220. Either of the servers 102a or 102n may so search, as indicated at 306 and 308.

Block 510 represents evaluating whether block 504 located any identification information for the endpoint. If so, then the process flows 500 may take Yes branch 512 to block 514, which represents extracting any identification information located for the endpoint.

Block 516 represents forwarding the endpoint identification information. FIG. 3 provides examples of the forwarded endpoint identification information at 314.

Block 518 represents forwarding the request received in block 502. FIG. 3 provides examples of the forward request at 310 and 312. Assuming a SIP implementation, the request may include an Invite with Replace request, as denoted in FIG. 3 at 310 and 312. In these instances, at least one of the requests (e.g., 310) may be acted on with reference to the endpoint identification information (e.g., 314).

Returning to block 510, if no identification information is located for the endpoint, then the process flows 500 may take No branch 520 directly to block 518. In these instances, the request may be acted on without the endpoint identification information.

The process flows 400 and 500 may allow the servers 102 to enable the endpoint device (e.g., 104a) to present endpoint identification information to a user or caller (e.g., 106a). The endpoint identification information as disclosed herein may be readily recognizable, understandable, and/or readable to a human user, as distinguished from, for example, a SIP Call ID (e.g., 212).

### CONCLUSION

Although the systems and methods have been described in language specific to structural features and/or methodological acts, it is to be understood that the system and method defined in the appended claims is not necessarily limited to the specific features or acts described. Rather, the specific features and acts are disclosed as exemplary forms of implementing the claimed system and method.

In addition, regarding certain data and process flow diagrams described and illustrated herein, it is noted that the processes and sub-processes depicted therein may be performed in orders other than those illustrated without departing from the spirit and scope of the description herein. Also, while these data and process flows are described in connection with certain components herein, it is noted that these data and process flows could be performed with other components without departing from the spirit and scope of the description herein.

1. At least one machine-readable storage medium comprising machine-readable instructions that, when executed by the machine, cause the machine to perform a method comprising:
receiving at least one response to a request to open a call session involving at least one endpoint; and
extracting human-understandable identification information from the response.

2. The machine-readable storage medium of claim 1, wherein the instructions for receiving at least one response include instructions for receiving a 200 OK response that is compliant with the Session Initiation Protocol (SIP).

3. The machine-readable storage medium of claim 2, wherein the instructions for extracting identification information include instructions for extracting the identification information from a P-Asserted Identity header associated with the response.

4. The machine-readable storage medium of claim 1, wherein the instructions for extracting identification information include instructions for extracting a dialing number associated with the endpoint.

5. The machine-readable storage medium of claim 1, further comprising instructions for receiving the request.

6. The machine-readable storage medium of claim 4, wherein the instructions for receiving the request include instructions for receiving a SIP Invite request.

7. The machine-readable storage medium of claim 4, wherein the instructions for receiving the request include instructions for receiving a request that includes at least a call identifier tag, which contains at least a non-human-readable alphanumeric string.

8. The machine-readable storage medium of claim 1, further comprising instructions for associating the identification information with the endpoint, and for storing the identification information.

9. The machine-readable storage medium of claim 8, further comprising instructions for extracting the identification information and for forwarding it along with a request from the endpoint to initiate a communication session.

10. The machine-readable storage medium of claim 8, further comprising instructions for extracting the identification information and for forwarding it along with a SIP Invite with Replace request from the endpoint.

11. An endpoint device for presenting the human-understandable identification information in connection with the SIP Invite with Replace request of claim 10.

12. A server comprising at least the machine-readable storage medium of claim 1.

13. At least one machine-readable storage medium comprising machine-readable instructions that, when executed by the machine, cause the machine to perform a method comprising:
receiving at least one request to open a call session from at least one endpoint; and
extracting previously-stored human-understandable identification information associated with the endpoint, wherein the identification information was extracted from a previous response transmitted from the endpoint.

14. The machine-readable storage medium of claim 13, wherein the instructions for extracting identification information include instructions for extracting a telephone number of the endpoint.

15. The machine-readable storage medium of claim 13, wherein the instructions for receiving at least one request include instructions for receiving a Session Initiation Protocol (SIP)-compliant Invite with Replace request from the endpoint.

16. An endpoint device for presenting the human-understandable identification information in connection with the SIP Invite with Replace request of claim 15.

17. The machine-readable storage medium of claim 13, further comprising instructions for identifying the endpoint, and for searching for human-understandable identification information associated with the endpoint.

18. The machine-readable storage medium of claim 13, further comprising instructions for forwarding the identification information for presentation by a destination endpoint.

19. The machine-readable storage medium of claim 13, further comprising instructions for receiving the previous response transmitted from the endpoint, wherein the previous response included a SIP-compliant 200 OK response, and wherein the previous response included the identification information in a SIP-compliant P-Asserted-Identity header.

20. A server comprising at least the machine-readable storage medium of claim 13.
